(19) United States
(12) Patent Application Publication
(10) Pub. No.: US 2007/0271299 A1
(43) Pub. Date: Nov. 22, 2007

(54) Environmental, Health and Safety Data Manager With Application Loaders

(75) Inventors: Jingjiu Wang, Oak Hill, VA (US); Wei Liu, Ashburn, VA (US); Leonid Solomon Oves, Potomac, MD (US); Alexis Antonio Ortiz, Silver Spring, MD (US); Yuliya Viktorova Tsvetkova, Silver Spring, MD (US)

Correspondence Address: PILLSBURY WINTHROP SHAW PITTMAN LLP, ATTENTION: DOCKETING DEPARTMENT, P.O BOX 10500, McLean, VA, 22102, US

(73) Assignee: 3E Company Environmental, Ecological and Engineering, Carlsbad, CA (US)

(21) Appl. No.: 11/691,356

(22) Filed: Mar. 26, 2007

Related U.S. Application Data
(60) Provisional application No. 60/785,957, filed on Mar. 24, 2006.
(60) Provisional application No. 60/871,772, filed on Dec. 22, 2006.
(60) Provisional application No. 60/787,966, filed on Mar. 31, 2006.

(51) Int. Cl. G06F 17/00

(52) U.S. Cl. 707/104.1; 707/E17.003

(57) ABSTRACT

Systems and methods are described that manage regulatory data associated with chemical products. Methods and systems are provided for tracking changes in regulatory data and other information associated with the chemical products. Data and information is collected from various sources, including government agencies and other regulatory authorities in plural jurisdictions, states and countries. Included in the regulatory data is information that governs handling, shipping and use of the chemical products. Systems and methods are described that provide filtering of a repository of regulatory data to determine its relevance to a customer's business and to analyze updates to assess impact on the business.

### CROSS-REFERENCE TO RELATED APPLICATIONS

The present application claims priority from U.S. Provisional Patent Application Ser. No. 60/785,957 entitled “Ariel Data Manager with Application Loaders,” filed Mar. 24, 2006, from U.S. Provisional Patent Application Ser. No. 60/871,772, entitled “Ariel Data Manager with Application Loaders,” filed Dec. 22, 2006 and from U.S. Provisional Patent Application Ser. No. 60/787,966, filed Mar. 31, 2006, entitled “Vendor MSDS Management and Regulatory Compliance Systems and Methods,” which applications are incorporated herein by reference and for all purposes.

### BACKGROUND OF THE INVENTION

### Description of Related Art

Global companies face the daunting challenge of efficiently monitoring continuously increasing and evolving complex requirements promulgated by regulatory agencies around the world. Managing information associated with environmental, health and safety compliance is a complex, time consuming, resource intensive and often expensive task. Manufacturers and distributors are especially challenged because they have complex internal and external obligations. Internally, they must ensure the safety of their own employees. Externally, they must ensure the safety of their products, provide information to their downstream customers, and comply with government regulations related to product registration, import/export, hazard communication, new chemical notification, reporting and restrictions on the marketing and use of hazardous substances.

### BRIEF SUMMARY OF THE INVENTION

Certain embodiments of the present invention provide environment, health and safety (“EH&S”) data integration, data management, and decision support systems and methods. Certain embodiments provide a data manager—hereinafter, “Ariel Data Manager” or “ADM”—that enables integration with customer EH&S applications, facilitating regulatory compliance, increased operational efficiencies and informed decision-making. Certain embodiments provide comprehensive, centralized global regulatory, (Material) Safety Data Sheet ((M)SDS), Chemical Safety Assessments (CSA), Chemical Safety Reports (CSR), Exposure Scenarios (ES), and other EH&S information that facilitates risk management and overall product and facility compliance. ADM can integrate relevant information from a variety of data sources and provide information required for making critical decisions related to a number of business issues that have to be considered when manufacturing and shipping products, including:
Managing corporate Governance, Risk, and Compliance (GRC) issues related to EH&S
Ensuring (M)SDSs are compliant within the markets in which the products are sold;
Ensuring compliance with international and country-specific regulatory requirements, such as:
   Inventory Status,
   Occupational Exposure Limits,
   Right-to-Know,
   Environmental (for example, Air, Water, and Waste),
   Product Safety,
   Classification, Packaging and Labeling,
   Dangerous Goods,
   Hazardous Materials Reporting,
   Health,
   Spill Reporting;
   Product Registration
   Registration, Evaluation and Authorization of Chemicals (REACH)
   Global Harmonized System (GHS)
Identifying physical and chemical properties of the chemicals and products
Identifying toxicological and eco-toxicological properties of the chemicals and products
Identifying regulatory authorities who require notification when exporting;
Identifying agencies that require notification in the event of a chemical release or spill;
Ensuring safe storage, handling, transport and disposal of substances; and
Ensuring products can be sold in the intended markets.

Certain embodiments provide systems and methods for tracking changes in regulatory information. Regulations are constantly changing and EH&S professionals are required to track hundreds of regulations in many jurisdictions as they apply to thousands of substances. Other sources of EH&S information, for example, collections of (M)SDSs, CSAs, CSRs, ESs are also subject to ongoing changes. Certain embodiments include decision support systems and methods that allow EH&S professionals to track and act upon changing information and to making informed decisions based on the information.

### BRIEF DESCRIPTION OF THE DRAWINGS

The present invention is illustrated by way of example, and not limitation, in the figures of the accompanying drawings in which like references denote similar elements, and in which:

FIG. 1 illustrates one example of an embodiment of the invention;

FIG. 2 illustrates loading of client system in an embodiment of the invention;

FIG. 3 illustrates an example of an Ariel Data Manager (ADM) integration with external systems;

FIG. 4 depicts a simplified load/setup workflow example according to certain aspects of the invention;

FIG. 5 depicts a simplified update workflow example according to certain aspects of the invention; and

FIG. 6 illustrates one example of an ADM.

### DETAILED DESCRIPTION OF THE INVENTION

The present invention will now be described in detail with reference to the drawings, which are provided as illustrative examples of the invention so as to enable those skilled in the art to practice the invention. Notably, the figures and examples below are not meant to limit the scope of the present invention. Where certain elements of the present invention can be partially or fully implemented using known components, only those portions of such known components that are necessary for an understanding of the present invention will be described, and detailed descriptions of other portions of such known components will be omitted so as not to obscure the invention. Further, the present invention encompasses present and future known equivalents to the known components referred to herein by way of illustration.

Certain embodiments of the present invention can increase efficiencies, improve data quality and currency, streamline processes, save EH&S professionals valuable time and, ultimately, support regulatory compliance. In certain embodiments, the ADM includes regulatory compliance systems and reliable content (hereinafter collectively referred to as “3E Content”) associated with EH&S activities may be provided to a variety of professionals with a wide range of EH&S responsibilities, including specialists, toxicologists, industrial hygienists, (M)SDS authors, material and emission specialists and transportation and logistical specialists.

3E Content can include distributed global regulatory databases, chemical expert databases such as databases of broad chemical classes, databases of chemical and physical properties, databases of toxicological and eco-toxicological information, multilingual phrase libraries, databases of meta-information extracted from (M)SDSs, and full text and images of documents such as (M)SDSs and Technical Data Sheets (TDSs)), and CSAs, CSRs, ESs. 3E Content may also include data sources obtained from third party entities interested in using the ADM as a vehicle to integrate their content into customer EH&S applications. Meta-information may include Material/Product Name, Manufacturer Name, Material/Part Number, Hazard Classifications including, for example, HMIS, NFPA, GHS, EU 67/548, WHMIS, DOT and others; Product Composition, Language, Country, (M)SDS Effective Date/Last Revision Date, Substance ID, Generation Variant, Physical Properties (including, for example, Flash Point, Boiling Point, and Density), pH, Chemical Properties, or other data elements requested by a customer.

In certain embodiments, the ADM may integrate various sources of EH&S information that are not provided or hosted by a centralized system. For example, the ADM may use REACH related data stores such as IUCLID5 as a source of information, integrating it into corporate EH&S applications. Such information may comprise structured data such as toxicological data and/or documents including CSAs, CSRs and ESs.

In one example, ADM users can review the classification for zinc powder according to EU Directive 67/548/EEC. Depending on whether a chemical has been stabilized or is in a pyrophoric state at a customer company, an appropriate classification can be selected in the ADM and served to downstream applications allowing an (M)SDS author, transportation specialists and others to consistently reference the appropriate classification. As needed, substance variants may be maintained to support chemical and hazard differences such as the hazards that are applicable when a substance is in a free flowing state and those that are applicable when the same substance is in an encapsulated state. Certain embodiments enable review of 3E Content at a component level and/or at a product level as well as the export of information into common applications such as Microsoft® Excel.

In certain embodiments, the ADM can enable easy and efficient change management and impact analysis. Typically the ADM can also ensure security and privacy by serving as a single repository of EH&S content residing inside a corporate firewall. Accessing content from a single source for use in multiple applications within an enterprise may also enable regulatory decision consistency and data integrity. In many embodiments, the ADM can retrieve content relevant to a particular business via the web through the use of secure HTTPS protocol XML/SOAP messaging. Prior to loading 3E Content into a customer system, the content may be reviewed and arranged for viewing in a variety of formats including formatting by source of content such as regulation (regulatory tree), by jurisdiction (jurisdiction tree), by topic (topical tree), by product (product tree) and by component (component tree). Loading decisions can be recorded at a substance variant or product level in a local centralized database so that future data maintenance is efficient and painless. Impact analysis can provide additional insight into the impact of content change on a business by presenting a complete view of changed elements through the display of the latest 3E Content alongside previously-stored content. For example, as regulatory changes occur and corresponding content updates are processed, recorded loading decisions can be used to determine whether content changes should be filtered or passed to downstream applications. Impact of changes can be assessed at the product (e.g., real substance) or at the component (e.g., listed substance) level, taking into consideration a variety of factors, including the recorded loading decisions and changes at the substance variant level and broad category of substances level.

In certain embodiments, the ADM comprises a massive aggregation of global regulatory content that can be delivered to EH&S corporate systems. This regulatory content can provide accurate, up-to-date, comprehensive global regulatory information containing hundreds of searchable chemical lists covering a plurality of countries and jurisdictions. The data may include product safety, EH&S legislation and directives on import/export, hazard communication, workplace safety, notification, reporting and prohibitions on the marketing and use of hazardous substances. In certain embodiments, systems and methods are implemented to support research for more than 600 regulatory lists covering nearly 3,000 data elements and maintain more than 320,000 regulated CAS numbers (i.e. Chemical Abstract Services numbers). Regulatory lists that could directly influence business processes and compliance practices are typically available for integration via the ADM. Access to a broader scope of regulatory information (e.g., full-text of regulations and compliance reviews, toxicological studies) may be available through web based systems including, for example, WebInsight by 3E Company of Carlsbad Calif., which system can be adapted for seamless integration with the ADM. A variety of risk assessment and risk management scenarios can be exercised via ADM-WebInsight integration. Thus, the system allows cross-referencing products with a wide array of chemical regulatory information. For example, the system may allow a user to assess how a change in a specific regulation would impact business.

In certain embodiments, the ADM comprises a massive aggregation of global multi-lingual (M)SDSs and the corresponding catalog of meta information extracted from or assigned to these (M)SDSs that is delivered to EH&S corporate systems. This aggregated global content can provide accurate, up-to-date, comprehensive EH&S information about products, including real substances. Certain web-based systems may provide access to a broader scope of (M)SDS-related information including, for example, classifications, product inventories, and (M)SDS archives. In one example, a web based system may be based on the 3E Online system of 3E Company of Carlsbad Calif., which system can be adapted for seamless integration with an ADM.

According to certain aspects of the invention, 3E Content may be updated in various ways using both automated and manual systems and methods. Additionally, data can be retrieved on-demand, and at any desired time, by a customer's system via the ADM. In one example, regulatory researchers can manually or automatically update content on a quarterly basis. In another example, automated systems can identify new content elements as candidates for update. The ADM may also use systems to cross-reference or identify product names with respect to generic names and vice-versa. In certain embodiments, systems such as the Ariel Generics System provided by 3E Company of Carlsbad Calif., can facilitate identification of regulatory requirements for chemicals that are not specifically named in regulations but are regulated as members of a broad group of chemicals or compounds, such as, for example, “cadmium compounds.” In one example, over 3,700 broad classes of chemical substances may be supported. In certain embodiments, (M)SDSs can be obtained globally and maintained on an ongoing basis. In certain embodiments, (M)SDSs can be authored by an outsourcing provider such as 3E Company of Carlsbad Calif.

In certain embodiments, an ADM comprises regional regulatory modules that can provide extensive coverage of regulated chemicals throughout the world at multiple levels of jurisdiction, from international, U.S. federal and state, to European Union (EU) member and non-member states. From the ADM, access to comprehensive collections of content can be provided through a context sensitive link to systems such as the WebInsight or 3E Online products of 3E Company of Carlsbad Calif. Native-language laws and regulations can be provided for those countries where an official English translation is not available. In certain embodiments, practical overviews and compliance guides provided by a Global Research Team can be provided in a common language, such as English, in order to support compliance efforts. Reference data is typically updated monthly and the integration data served by ADM can be updated at regular intervals to ensure currency. Intervals can be selected based on the frequency of changes expected, importance of the information and other factors. Intervals can be selected to be annual, semi-annual, quarterly, monthly, weekly, daily, hourly, as change occurs or at other predetermined or configurable intervals. Users can typically subscribe to any combination of available data and full text modules, which can include North America, Western Europe, Central & Eastern Europe, Latin America, Asia-Pacific, Middle East and Africa, Physico-Chemical, Tox, and Ecotox, and Dangerous Goods.

In certain embodiments, the ADM includes a Global Inventories module that can provide comprehensive and easy-to-use national inventory coverage. Newly published inventories can be incorporated as they are released. For example, inventories can include U.S.A., European Union, Switzerland, Canada, Australia, New Zealand, Korea, The Philippines, Japan, and China. In certain embodiments, the ADM includes a Vendor (M)SDS module that can provide access to a comprehensive up-to-date collection of global multi-lingual (M)SDSs. In certain embodiments, the ADM includes a REACH module that can provide access to comprehensive regulatory information stored in REACH IT databases.

In certain embodiments, on-demand access to content is provided whereby content can be pulled on-demand at any time, including after new substances or products enter the workplace, formulations change, products are sold in new markets or new versions of content are published.

In certain embodiments, change management tools can be provided to efficiently support business adoption of regulatory changes. For example, insightful regulatory change impact analysis reports can be provided that enable a customer to identify how a change impacts the customer's business. Impacts may include the extent of required resource re-allocation, the impact of a chemical regulatory change on downstream products and/or impact on corporate sustainability and GRC programs. In certain embodiments, the ADM can enable identification of the impact of regulatory change over a number of specified criteria, including, for example, period of time, including regulatory scope and product/composition. The ADM can support the display of changed values and current values for substances.

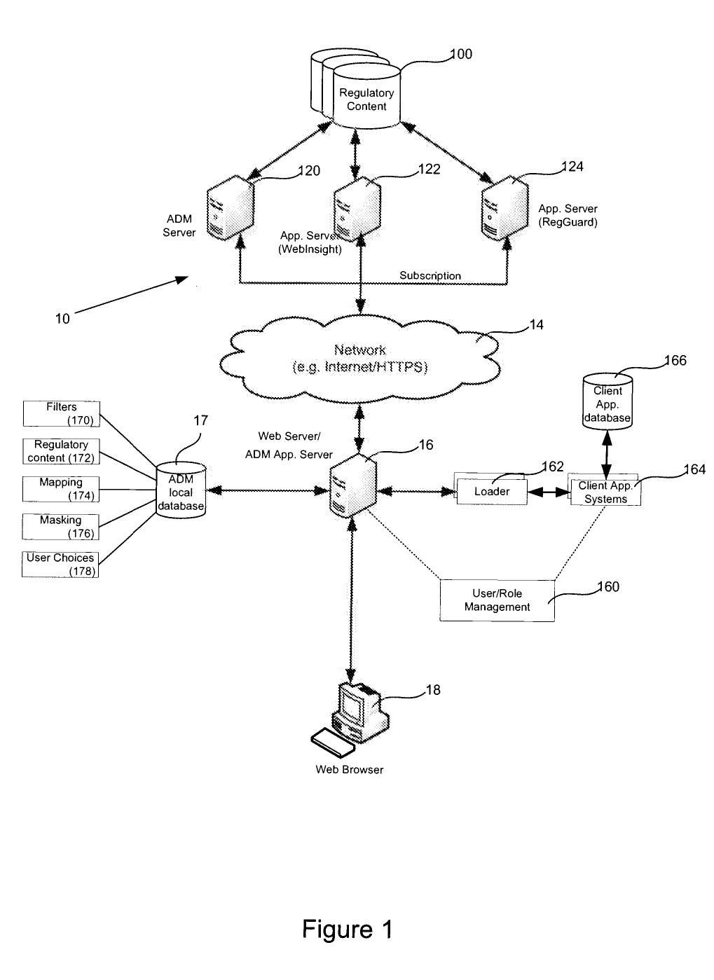

FIG. 1 illustrates a generalized example of a system according to certain aspects of the invention. In the example, a central ADM system 100 comprises databases 100 and servers 120, 122 and 124. 3E data, including regulatory content, can be maintained in one or more databases 100. Access to the one or more databases 100 is typically provided through central ADM server 120 and other servers 122 and 124. These other servers can provide subscription-based access to portions of the regulatory data maintained in the one or more databases 100 and may be configured as application servers that respond to user queries, requests and configuration. Application servers 122 and 124 may be used to assemble and view portions of the data maintained in the databases 100. Application servers 122 and 124 may be used to assemble and transfer portions of the data maintained in the databases 100 to user systems or to other EH&S systems or ADM-based systems. Application servers 122 and 124 may be used to assemble portions of the data maintained in the databases 10 in order to generate reports, such as compliance reports.

In certain embodiments, a local ADM server 16 may be provided to maintain a local ADM database 17 and to provide information to proprietary, client or other third party database systems 166. Local ADM server 16 can be implemented on a customer site or in a central location that provides service to one or more customers or a plurality of users in an organization, including geographically dispersed organizations. Local ADM server 16 may be implemented as an application server that communicates with the central ADM system 10 using a network 14 that is typically the Internet. Secured communications can be provided using, for example, HTTPS, PGP, RSA and other suitable or desired encryption methods.

In certain embodiments, a plurality of processes, functions and systems can be provided to manage data transferred to and maintained by the local ADM database 17. Processes may be distributed between the centralized ADM system 10 and the local ADM server 16 as deemed necessary or desirable. In one example, the local ADM database 17 can maintain for each of its users, filters 170, regulatory content 172, mappings of centralized data 10 to local data 17, masking 176 and user configurations and selections. However, in at least some embodiments, user-specific information can be maintained in a centralized database 10 or server 120, 122, 124. In some embodiments, such information may be maintained in some combination of local and centralized storage. Other forms of information may be maintained in similar fashion, including user identification, demographics, histories of transactions and archived results.

In certain embodiments, an ADM server 16, 120 or App server such as 122 or 124 may interface client or third-party systems to 3E data maintained in databases 10 and 17. Typically, one or more loaders 162 can be configured to retrieve and receive 3E data and provide the 3E data to a proprietary or commercial application or system 164. The received or retrieved 3E data may be maintained by the third-party in a database 166. In certain embodiments, communication and interaction between an ADM server 16 and the third-party application or system can be controlled by custom or preconfigured management processes 160. In one example, the management process 160 may provide filters 170, maps 174 and masks 176, etc. to identify the types of information that is relevant to the third-party systems 164.

In certain embodiments, users can interface with the local ADM server 16 through a computing device 18 such as a terminal, a computer, a wireless device, etc.

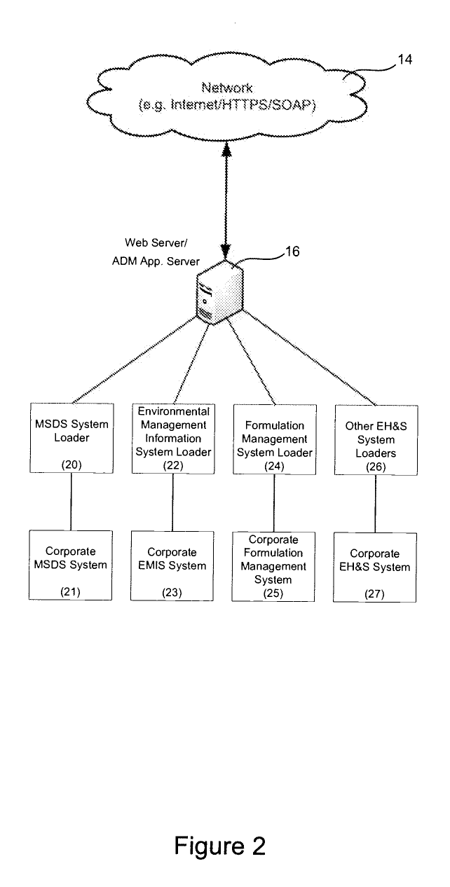

Referring now also to FIG. 2, certain embodiments include loaders 20, 22, 24 and 26 for exchanging 3E data between an ADM system 10 and third-party applications or systems 164. In many instances, the 3E data is maintained in a local ADM database 17. Loaders 20, 22, 24 and 26 can be used to reformat, cross-reference and preprocess data prior to entry in corporate systems 21, 23, 25 and 27. Loaders can be provided for each of a different type of 3E data. In the example of FIG. 2, (M)SDS information, including MSDS data sheets can be loaded into a customer MSDS system 21 using an MSDS loader 20, an environmental management information system (“EMIS”) 23 can be loaded using an EMIS loader 22, a formulation management system (“FMS”) 25 can be loaded using an FMS loader 23 and so on.

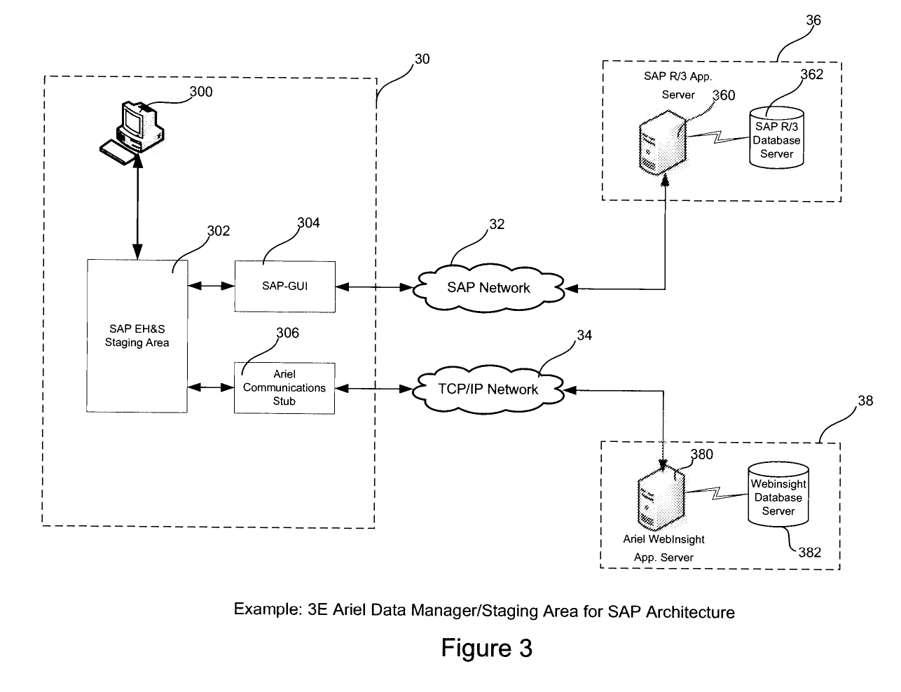

FIG. 3 provides a generalized depiction of an embodiment that communicates with a commercially available SAP-based system 36. The interface 30 comprises a staging area component 302 that permits communication between elements of the presently claimed ADM system 38 and the SAP-based system 36. The SAP-based system 36 may communicate over a private or public network 32. In certain embodiments, the ADM communicates using the Internet 34 or through some other network that can be distinct from or the same as the SAP network 32. Typically, the interface 30 provides GUI-based interaction 304 with users of the SAP-based system. An ADM communications component 306 facilitates communication between the interface 30 and the ADM 38. The ADM 38 may comprise an application server 380 and database 382. In certain embodiments, the interface 30 may communicate with a centralized ADM system 10. The staging area 302 typically provides conversion services that can receive requests in one system, access required information from the second system and reformat the data for the first system. The staging area may be directly accessible using any suitable computing device 300. Certain additional concerning the example of FIG. 3 is provided below.

In certain embodiments, cross-platform capabilities may be provided. The ADM typically uses industry-standard and open technologies in a highly secure distributed environment. The ADM can be provided to be compatible with industry standard databases such as Oracle, SQL Server and Access. The ADM may include loaders that can feed 3E Content into a variety of EH&S enterprise systems. In certain embodiments, product and formulation information typically remains inside the customer's firewall and all service requests and responses can be adapted to flow over the Internet using the highly secure HTTPS protocol.

In certain embodiments, ADM may be seamlessly integrated with tools that provide reference, data collation, analysis and presentation functions. In one example, the ADM is integrated with a suite of tools from 3E Company of Carlsbad Calif., the suite comprising an online web-based global chemical regulatory compliance tool (e.g. “Ariel Webinsight”), a tool that provides automatic alerts to changes in regulatory information (e.g. “Ariel RegGuard”), and a tool that provides access to global collections of (M)SDSs and related information (e.g. “3E Online”). Typically, any of a plurality of services can be configured with a variety of options and enhancement modules that can be integrated into conventional and industry standard EH&S systems, custom systems, or in combinations of systems and services configured based on a customer's EH&S information management needs. In certain embodiments, access and use of ADM can be provided as a subscription service.

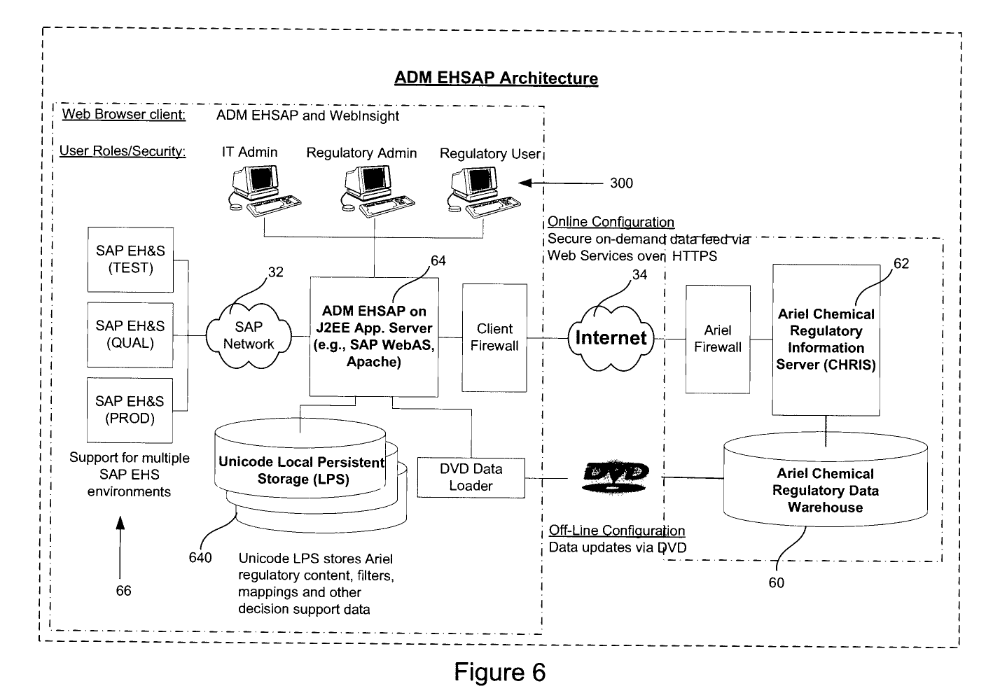

FIG. 6 shows a block schematic of one example of an embodiment according to certain aspects of the invention. In the example, systems by 3E Corporation of Carlsbad, Calif. provide access to regulatory database 60 using one or more servers 62 and 64. The Ariel Chemical Regulatory Warehouse 60 can be maintained and accessed through a centralized server 62, typically operated by a service provider. Access can be provided as online access and offline access, the latter type of access providing configuration and data updates using storage such as DVD, CD and so on. Certain combinations of online and offline accesses are contemplated an online access can include occasional or periodic connections between a user and a service provider.

Server 64 can be provided at a user site or at a service provider site. In the latter instance, the service provider can offer customized features and functions for one or more users. Server 64 can receive and process regulatory data and can store some or all of the received regulatory data in local persistent storage 640. Server 64 typically provides an interface to one or more third-party or commercially available systems 66 including, for example, systems provided by SAP. As depicted in the example, classes of user 300 can be defined to include administrative users responsible for maintaining the various systems, regulatory administrators responsible for managing the regulatory content, filters, queries, configuration and so on and regulatory users who use the regulatory data. Other classes and sub-classes of users can be defined as necessary.

As described in the above examples, the ADM may be characterized as an EH&S content integration, data management and decision support solution that enables a data and document flow into a customer's EH&S applications, facilitating improved compliance, increased operational efficiencies and informed decision-making. The ADM can typically provide relevant information that is required for making critical decisions related to business issues associated with manufacturing and shipping products. Business issues that can be addressed include ensuring (M)SDSs are compliant within the markets in which the products are sold, identifying regulatory authorities that require notification when exporting, knowing which agencies have to be notified in the event of a chemical release or spill, ensuring the safe storage, handling, transport and disposal of substances, ensuring products that can be sold in the intended markets. Such comprehensive, centralized global regulatory and (M)SDS information can typically satisfy requirements for overall product and facility compliance.

The ADM may support data integration and can comprise interfaces to other proprietary or commercially available products. In one example, the ADM can be integrated with Worldwide Environmental & Regulatory Compliance Systems (“WERCS”) products. Software for delivering 3E Content into ERP or EH&S systems can also include a loader specific to a desired WERCS platform. The ADM typically features an intuitive client-server interface and/or a web interface that facilitates easy loading of content into WERCS and an enhanced decision support functionality that can ensure that data loaded by users for use in their applications is limited to data relevant to their business.

In certain embodiments, the ADM can be integrated with commercially available products such as EH&S products provided by SAP®. In one example the ADM can be used for delivering 3E Content and third party content into proprietary and commercial ERP or EH&S systems and the ADM may include a loader specific to the SAP® EH&S platform. The ADM typically features an intuitive client-server and/or web interface that facilitates quick and easy loading of data into SAP® EH&S and the ADM (the combination hereinafter referred to as “ADM/EHSAP) can provide enhanced decision support functions that can ensure only data relevant to a user's business and for use in user's applications is loaded. For example, the classification according to EU Directive 67/548/EEC for zinc powder may be reviewed within ADM/EHSAP. Depending on whether the chemical has been stabilized or is in a pyrophoric state at a company, the appropriate classification can be selected in ADM/EHSAP and shared with other users throughout an enterprise, enabling (M)SDS Authors, Transportation Specialists and others to consistently reference the appropriate classification. As needed, substance variants may be maintained to support chemical and hazard differences such as the hazards that are applicable when a substance is in a free flowing state and those that are applicable when the same substance is in an encapsulated state.

In another example, an (M)SDS in full text or image format and corresponding meta information may be requested over the web for a hit list of real substances generated in SAP® EH&S. Searches for such information in sources of 3E Content can be performed and results may be presented to users of the ADM for review. Based upon such review, the requested information can be stored in SAP® EH&S. In some instances, (M)SDSs may be stored in a document management system (“DMS”) and the meta data may be stored in the SAP® EH&S data structure (a.k.a. the Property Tree). In addition, a user can choose to link real-substance data to existing or new listed substances in order to ensure referential integrity of the product composition data and support related SAP® EH&S functions. In another example, REACH data and documents (e.g., hosted in the IUCLID5 system) can be loaded into SAP® EH&S. In some instances, XML-formatted data and documents can be loaded via the ADM into SAP® EH&S.

In certain embodiments, the ADM can permit only uploading and reviewing of changes to 3E Content. In certain of these embodiments, users of WERCS may no longer have to follow the conventional procedure of reloading all regulatory data at every update. In certain embodiments, support for regulatory groups (“Generics”) is provided to enable users to accurately select an appropriate group of chemicals to which a chemical belongs and to save their selections for future use. Conventionally, detailed knowledge of chemistry is needed to determine the right group that applies, particularly where chemical substances are regulated as members of multiple groups. Thus embodiments of the invention can enable users to more easily make decisions regarding the applicability of Generics.

In certain embodiments, a synchronization mechanism (“Data Sync”) enables scheduling of content updates over the Internet. For example, a tool can be provided that operates entirely in the background and synchronizes the customer's local database with a suitable configured central server. The ADM may also connect to other servers that store 3E Content or external content servers that expose data via web-based services. In certain embodiments, multiple database support is provided that can facilitate and maintain additional data categories, including toxicity, eco-toxicity, physical and chemical properties. Furthermore, in some embodiments WERCS-specific features are supported, including improved mapping and masking features that can allow creation of multiple maps per single Ariel regulation, multiple masks per mapping, and an ability to load regulatory data for a specific product or component and specific regulatory scope.

In certain embodiments, the functionality provided by the ADM is complemented by data integration productivity tools that can enable EH&S professionals to analyze the impact of regulatory changes on the business and improve processes for adopting changes. These additional tools may also facilitate maintenance of regulatory filters and constructing hit lists.

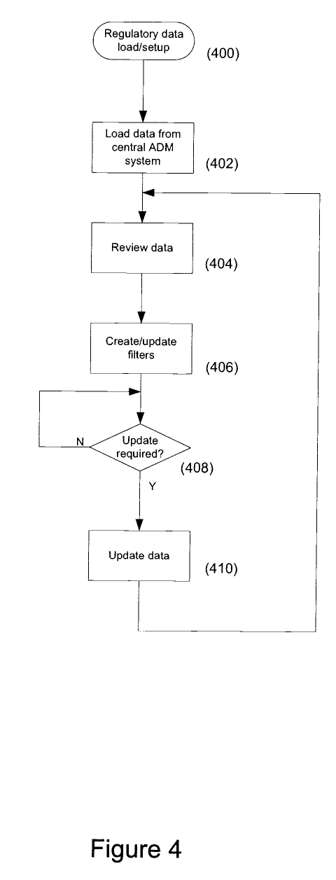

Turning now to FIG. 4, an example of initial regulatory data load and setup is illustrated. At step 402, regulatory data may be loaded into a local ADM regulatory data repository. The local ADM repository may be maintained in a database, typically accessible through a server. Regulatory data can be reviewed 404 and updated 408 periodically or in response to changes in regulatory data provided by a regulatory authority. Periodical updates can be based on the nature of the regulatory data, frequency of changes to the regulatory data and mandated update schedules, including government and/or regulatory authority mandated review, update and/or reporting periods. Consequently, tools are provided to maintain the regulatory data and certain of the tools may be configured to facilitate reviewing 404 and updating 410 the data. Configuration at step 406 may involve modifying views, queries and reports. Configuration may also include identifying forms and formats of documents to facilitate location of significant elements of the regulatory data. Configuration 406 may also include cross-referencing data within regulatory data documents and between regulatory data and other related data. For example, information in regulatory data may be summarized, extracted or indexed under one or more categories.

In certain embodiments, regulatory filters may also be created at step 406 to accumulate, aggregate, summarize and/or categorize regulations for one or more specific geographic regions, regulatory topic and/or for all new regulations downloaded from a central regulatory database or system and from external repositories. Step 406 provides for the creation of component filters based on criteria such as a product name, CAS number, date created, list of CAS numbers, and so on.

Review of regulatory data at step 404 may be performed based on chemicals and based on regulations. Certain embodiments of the invention assign regulatory codes and map the regulatory codes to corresponding regulatory codes defined in a host EH&S application. Mapping of regulatory data may require configurable or customizable systems to ensure that the regulatory data populates appropriate fields of host EH&S applications. In some embodiments, a map can be provided manually although many embodiments provide systems that can analyze requirements of EH&S applications in order to automatically generate suitable maps.

In certain embodiments, a review of regulatory data 404 can include an analysis of generics data in order to ascertain which generics data should be loaded into a host EH&S application. In one example, different regulatory values may be assigned based on distinctions in classes, types or families of chemicals (e.g. whether the chemical is barium or zinc compound). The ADM can accurately associate chemicals with corresponding compounds and can record generics-related decisions so that a regulatory update populates only the value for the selected compound.

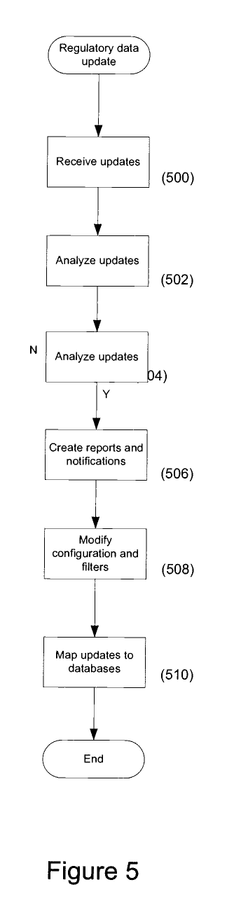

Turning now to FIG. 5, an example of a regulatory data update is illustrated. At step 500, received regulatory updates can be analyzed and used to update a regulatory data repository maintained locally by an ADM. In one example, update reception includes using one or more data synchronization utilities to pull regulatory updates from a central regulatory database to the local ADM-maintained regulatory data repository at a certain scheduled date and time. In this manner the central regulatory database can be maintained independently of a plurality of customized systems. Raw documents can be maintained together with preformatted and indexed data derived from the raw documents. The raw documents can include documents provided directly by regulatory authorities and documents authored, translated and/or filtered from information provided by regulatory authorities. The raw documents may also include versions of certain documents that include a series of revised documents that reflect one or more incremental changes.

Certain embodiments provide tools and systems that can analyze regulatory changes in order to assess regulatory change impact. Upon analysis at step 502, if any significant impact is determined at step 504, then reports and notifications can be created at step 506. Reports can be provided in any suitable format, including Excel spreadsheets, HTML, XML and printed reports. Reports typically detail all changes related to the regulatory data from one regulatory update to another and can provide information identifying the effects of the changes, particularly regarding compliance requirements. In certain embodiments, the impact of regulatory change on certain regulatory or component filters may be determined at step 508 an appropriate modification or reconfiguration can be indicated. Where customized or preconfigured filters are maintained for different EH&S systems, filter updates can be coordinated to occur in synchronism with regulatory data updates.

In certain embodiments, user intervention may be required to authorize loading of new or change regulatory data into a host EH&S application. In one example, a user is required to select a button on a display, and may be required to enter a password or other indicia of identification in order to actively accept changes to data and filters, etc. Accordingly, a report summarizing the changes may be presented to the user. In some embodiments, the user can be directed to the report by a notification of change and, having been accorded the opportunity to review the changes prior to authorizing the changes. In certain embodiments, updates may be performed automatically without user invention although some embodiments include methods for reversing or backing-out all or a portion of changes as needed. At step 510, updates are performed, typically by background loading of data into the host EH&S application repository.

### Additional Descriptions of Certain Aspects of the Invention

In certain embodiments, an ADM comprises a current and complete regulatory database in which Product Safety and Dangerous Goods regulations from around the world, including the North American, Western European, Eastern European, Asia-Pacific, Latin American and Middles Eastern regions, as well as Physico-Chemical, Toxicological, and Ecotoxicological, are maintained. This database may include a primary linkage between regulations and substances based upon key chemical identifiers, such as CAS RN, and may also include linkages between substances and broad categories of chemicals which are often listed on regulations (generics).

In certain embodiments, an ADM comprises a multi-tier distributed System and Database Architecture in which a customer can maintain a copy of all Ariel data relevant to the customer's business and can periodically update this database. Update may be effected using a Web-based connection to Ariel's data server using SOAP technology (on-demand mode) and by way of uploading a DVD copy of the database (batch mode).

In certain embodiments, an ADM can further comprise a User Interface which uses standard Web-based technologies, such as Java or .Net, that allows users to access the data-loading application from virtually any PC globally.

In certain embodiments, an ADM can further comprise a User Management and Security system (“UMS”) that allows customers to establish multiple user roles and to assign data management and compliance functions to different users. Such roles may include a systems administrator, a regulatory administrator, a regulatory user, and an outsourcer. For example, an outsourcer role may allow making or reviewing regulatory choices but would not allow saving information to a corporate system. In some embodiments, this UMS can include systems and methods for the creation and maintenance of a Master Filter, identifying all regulations that are relevant to any given company's business, and of various User Filters, which are always a subset of the Master Filters.

In certain embodiments, an ADM can further comprise a user workflow by which initial data uploads and subsequent data updates can be accurately entered and easily managed. In some embodiments, the user workflow synchronizes a local copy of the regulatory database, as applicable to customers' needs, with a fully updated version of the regulatory database. Synchronization can be performed online using the Internet or other network, or off-line using, e.g., a DVD. Synchronization of the database can be accomplished for all relevant regulatory data at regular intervals, as scheduled by the user. In addition, as new regulatory data or new products and/or compositions become relevant to the user, such items can be synchronized on demand.

In certain embodiments, mapping tables and corresponding configuration settings (e.g., mapping and masking in WERCS or customizing in SAP EH&S) can be established in accordance with regulatory descriptions, codes and values that can be mapped to customer-specific entries. This can include an ability to automatically create configuration settings and import-ready phrase files directly from the mapping tables.

In certain embodiments, an impact analysis process can be performed whereby users can identify how components (e.g., listed substances) and products (e.g., real substances) will be affected by changes to regulatory requirements. This can include functionality that allows users to consider various ‘what-if’ scenarios, based on a number of flexible criteria, such as System, Date-ranges, and Regulatory Filters settings.

In certain embodiments, regulatory filters can be established and maintained that may be configured to determine the relevance of regulations within the database to the customers' business needs. When an update is received new or sunset regulations which become available can be identified and reviewed. Users, system administrators and other authorized individuals and systems can modify and/or reconfigure master filters maintained on a server user filters maintained in or for user systems.

In certain embodiments, a decision support process is provided by which users can determine applicability of particular data values to the chemical substances used, wherein the chemical substances can be chemical product, compounds, intermediates and elements. In one example, the decision support system can determine applicability of chemicals that are not directly regulated and chemicals that may be subject to conflicting regulatory provisions.

In certain embodiments, errors in loaded data can be identified in a test-load/roll-back process. In one example, errors can include data referential integrity, phrase settings and/or configuration errors, prior to loading data. In certain embodiments, any set of chemicals can be loaded into a corporate EH&S system/database.

In certain embodiments, the relative importance of regulations can be determined based on individual business needs. Decisions associated with such determinations can be stored and/or archived such that users can easily identify which regulations have been affected by an update. Users may typically review all information before it is loaded into a user-specific or user-maintained EH&S system, enabling informed decision-making related to the organization's product safety and stewardship requirements.

In certain embodiments, an ADM can further comprise a rule-based Decision Support methodology by which users can apply automation to process of identifying where business-related decisions are necessary and for making such decisions. In many embodiments the rule-based Decision Support process can enable users to identify cases in which regulatory and business decisions are needed. In some embodiments, a Generics Management process is included by which users can determine in which cases they wish to review regulatory data that is applicable through generic linkages. This can include the possibility to review all generics entries, only generics which conflict with other generic entries, only generic entries that do not conflict with others, and the ability to establish the applicability of generics either per regulation or across all regulations. In some embodiments, a Data Management process is included by which users can identify potentially conflicting data points in cases where chemicals are not regulated under Generic groupings. Furthermore, ADM supports multiple views, for example, show all data, show selected data, show deselected data, show data where a decision to load or not to load has been postponed (undecided), show only decision points (e.g., data conflicts described above). In many embodiments, a rule-based Decision Support process is included by which users can automate the process of making decisions by establishing certain pre-defined scenarios (for example, always selecting the most conservative values, always select a direct hit over the generic one, etc).

In certain embodiments, an ADM can further comprise a flexible, condition-based mapping process by which user can determine where they will load regulations or other 3E Content. Such conditional mapping would evaluate data elements dynamically to define where they should reside in a corporate system. In one example, regulations can be loaded into a selected SAP EH&S property based upon regulation code, validity area or other criteria.

In certain embodiments, an ADM/EHSAP is provided for SAP's transportation module that provides regulatory data for the transportation of hazardous materials globally. In some embodiments a Dangerous Goods database is included that comprises all information necessary for complying with regulatory requirements including ADR—European Agreement for concerning the International Carriage of Dangerous Goods by Road; RID—Regulations concerning the International Carriage of Dangerous Goods by Rail; IATA—International Air Transport Association Dangerous Goods Regulations (passenger and cargo); IMDG/IMO—International Maritime Dangerous Goods Code; ADNR—Agreement on the Transport of Dangerous Goods on the Rhine; US 49CFR—United States Transportation of Hazardous Materials Regulations (U.S. DOT); and Canadian TDG—Canadian Transportation of Dangerous Goods Regulations.

In some embodiments ADM/EHSAP a is configurable to support SAP's chemical property and hazard data provides in-depth physical, chemical, toxicological and eco-toxicological data, including in excess of 8,000 of the most common substances. In these embodiments, understanding is facilitated of the physical and chemical properties and the toxicity and eco-toxicity of the substances used in product formulations such that EH&S professionals are enabled to make informed decisions related to the impact of the chemicals, their processes and their products on their workers, the workplace and the environment.

Certain embodiments of the invention provide a method of managing regulatory information associated with environment, health and safety data, comprising maintaining a database of regulatory data associated with a plurality of chemical products, mapping selected elements of the regulatory data to corresponding elements in a user system, wherein the selected elements are associated with chemical products identified by the user system, updating the regulatory data with regulatory updates received from a plurality of regulatory authorities, wherein the regulatory updates include data retrieved from a networked server, and synchronizing the corresponding elements with the selected element, wherein the synchronizing includes communicating certain of the selected elements to the corresponding elements. In certain embodiments, the updating includes filtering the regulatory updates to categorize the regulatory updates by regulatory topic. In certain embodiments, the updating includes filtering the regulatory updates to accumulate regulatory updates for one or more regions. In certain embodiments, wherein the synchronizing includes remapping the regulatory data to the user system responsive to information provided in the regulatory updates. In certain embodiments, the updating is performed periodically. In certain embodiments, a frequency of updating is mandated by a government. In certain embodiments, a frequency of updating is mandated by a regulatory authority. In certain embodiments, the updating is performed responsive to a user system request. Certain embodiments further comprise initiating the corresponding elements in the user system by communicating the selected elements of the regulatory data to the user system. Certain embodiments further comprise generating a compliance report for the each of the identified chemical products based on the selected elements. In certain embodiments, the updating includes updating the compliance reports for certain of the identified chemical products. In certain embodiments, the updating includes notifying the user system of impact of the regulatory updates on compliance requirements. In certain embodiments, the notifying includes sending an electronic message.

Certain embodiments provide a method of tracking environmental health and safety compliance with regulatory provisions governing chemicals, comprising accumulating information associated with a plurality of chemicals in a database, the accumulated information including regulatory data corresponding to each of the chemicals, maintaining regulatory filters for a customer, wherein the regulatory filters are configured based on relevance of the regulatory data to the customer, filtering the regulatory accumulated information using the regulatory filters to obtain compliance information relevant to the customer, providing the customer with the compliance information. In certain embodiments, the accumulated information includes information obtained from distributed global regulatory databases and chemical expert databases. In certain embodiments, the accumulated information includes information obtained from data sheets related to the plurality of chemicals. In certain embodiments, the relevance is measured by determining the applicability of portions of the regulatory data to one or more chemical products identified by the customer. In certain embodiments, wherein the applicability is determined based on chemical compositions of the identified chemical products. In certain embodiments, the applicability is determined by identifying regulatory requirements for the identified chemical products based on regulatory requirements for a group of chemicals that includes one or more of the chemical compositions. In certain embodiments, the accumulated information is obtained from a plurality of regulatory authorities. In certain embodiments, the accumulated information includes periodic updates received from certain of the regulatory authorities. In certain embodiments, the periodic updates are mandated by the certain regulatory authorities. Certain embodiments further comprise analyzing the impact of changes to regulatory requirements affecting the identified chemical products, wherein the changes are obtained from the periodic updates. Certain embodiments further comprise analyzing the impact of changes to regulatory requirements regarding the chemical compositions. In certain embodiments, the changes are derived from updates to the accumulated information. In certain embodiments, the applicability is determined by a user. Certain embodiments further comprise providing the customer with filtered regulatory data that includes the portions determined to be applicable. Certain embodiments further comprise providing the customer with updated filtered regulatory data responsive to receiving an update from one or more of the regulatory authorities. In certain embodiments, the accumulated information includes an identification of physical and chemical properties of chemicals identified in material safety data associated with one or more of the identified chemical products. In certain embodiments, the accumulated information includes an identification of toxicological properties of chemicals identified in material safety data associated with one or more of the identified chemical products. In certain embodiments, the accumulated information includes regulations governing transportation and use of chemicals identified in material safety data associated with one or more of the identified chemical products. In certain embodiments, the regulations comprise regulations provided by a plurality of jurisdictions. In certain embodiments, the regulations include regulations governing transportation of the one or more of the identified chemical products. In certain embodiments, the regulations include regulations governing use of the one or more of the identified chemical products. In certain embodiments, the regulations include regulations governing sale of the one or more of the identified chemical products.

Certain embodiments of the invention include a system for managing regulatory information associated with environment, health and safety data, comprising a warehouse of regulatory data associated with a plurality of chemical products, a database configured to maintain selected elements of the regulatory data, wherein the selected elements correspond to chemical products identified by a user, a regulatory server configured to update the regulatory data with regulatory updates received from a plurality of regulatory authorities, wherein the regulatory updates include data retrieved from at least one networked server. Certain embodiments further comprise an application server configured to receive regulatory information from the regulatory server and store portions of the regulatory information in the database, wherein the portions are related to one or more of the selected elements. In certain embodiments, the regulatory information includes updates of the regulatory data. Certain embodiments further comprise a plurality of filters maintained by the application server, wherein the filters operate to select the portions for storage in the database. In certain embodiments, the filters select the portions based on relevance of the portions to the chemical products. In certain embodiments, the relevance is determined based on chemical compositions of the chemical products. In certain embodiments, the relevance is determined by identifying regulatory requirements for the chemical products based on regulatory requirements for a group of chemicals that includes one or more of the chemical products. In certain embodiments, the information includes data obtained from distributed global regulatory databases and chemical expert databases. In certain embodiments, the accumulated information includes information obtained from data sheets related to the plurality of chemicals. In certain embodiments, the regulatory data is obtained from a plurality of regulatory authorities.

It is apparent that the above embodiments may be altered in many ways without departing from the scope of the invention. Further, various aspects of a particular embodiment may contain patentably subject matter without regard to other aspects of the same embodiment. Additionally, various aspects of different embodiments can be combined together. Also, those skilled in the art will understand that variations can be made in the number and arrangement of components illustrated in the above diagrams. It is intended that the appended claims include such changes and modifications.

What is claimed is:

1. A method of managing regulatory information associated with environment, health and safety data, comprising:
maintaining a database of regulatory data associated with a plurality of chemical products;
mapping selected elements of the regulatory data to corresponding elements in a user system, wherein the selected elements are associated with chemical products identified by the user system;
updating the regulatory data with regulatory updates received from a plurality of regulatory authorities, wherein the regulatory updates include data retrieved from a networked server; and
synchronizing the corresponding elements with the selected element, wherein the synchronizing includes communicating certain of the selected elements to the corresponding elements.

2. The method of claim 1, wherein the updating includes filtering the regulatory updates to categorize the regulatory updates by regulatory topic.

3. The method of claim 1, wherein the updating includes filtering the regulatory updates to accumulate regulatory updates for one or more regions.

4. The method of claim 1, wherein the synchronizing includes remapping the regulatory data to the user system responsive to information provided in the regulatory updates.

5. The method of claim 1, wherein the updating is performed periodically.

6. The method of claim 5, wherein a frequency of updating is mandated by a government.

7. The method of claim 5, wherein a frequency of updating is mandated by a regulatory authority.

8. The method of claim 1, wherein the updating is performed responsive to a user system request.

9. The method of claim 1, and further comprising initiating the corresponding elements in the user system by communicating the selected elements of the regulatory data to the user system.

10. The method of claim 1, and further comprising generating a compliance report for the each of the identified chemical products based on the selected elements.

11. The method of claim 10, wherein the updating includes updating the compliance reports for certain of the identified chemical products.

12. The method of claim 1, wherein the updating includes notifying the user system of impact of the regulatory updates on compliance requirements.

13. The method of claim 12, wherein the notifying includes sending an electronic message.

14. A method of tracking environmental health and safety compliance with regulatory provisions governing chemicals, comprising:
accumulating information associated with a plurality of chemicals in a database, the accumulated information including regulatory data corresponding to each of the chemicals;
maintaining regulatory filters for a customer, wherein the regulatory filters are configured based on relevance of the regulatory data to the customer;
filtering the regulatory accumulated information using the regulatory filters to obtain compliance information relevant to the customer;
providing the customer with the compliance information.

15. The method of claim 14, wherein the accumulated information includes information obtained from distributed global regulatory databases and chemical expert databases.

16. The method of claim 14, wherein the accumulated information includes information obtained from data sheets related to the plurality of chemicals.

17. The method of claim 14, wherein the relevance is measured by determining the applicability of portions of the regulatory data to one or more chemical products identified by the customer.

18. The method of claim 17, wherein the applicability is determined based on chemical compositions of the identified chemical products.

19. The method of claim 18, wherein the applicability is determined by identifying regulatory requirements for the identified chemical products based on regulatory requirements for a group of chemicals that includes one or more of the chemical compositions.

20. The method of claim 17, wherein the accumulated information is obtained from a plurality of regulatory authorities.

21. The method of claim 20, wherein the accumulated information includes periodic updates received from certain of the regulatory authorities.

22. The method of claim 21, wherein the periodic updates are mandated by the certain regulatory authorities.

23. The method of claim 21, and further comprising analyzing the impact of changes to regulatory requirements affecting the identified chemical products, wherein the changes are obtained from the periodic updates.

24. The method of claim 18, and further comprising analyzing the impact of changes to regulatory requirements regarding the chemical compositions.

25. The method of claim 24, wherein the changes are derived from updates to the accumulated information.

26. The method of claim 18, wherein the applicability is determined by a user.

27. The method of claim 18, and further comprising providing the customer with filtered regulatory data that includes the portions determined to be applicable.

28. The method of claim 27, and further comprising providing the customer with updated filtered regulatory data responsive to receiving an update from one or more of the regulatory authorities.

29. The method of claim 17, wherein the accumulated information includes an identification of physical and chemical properties of chemicals identified in material safety data associated with one or more of the identified chemical products.

30. The method of claim 17, wherein the accumulated information includes an identification of toxicological properties of chemicals identified in material safety data associated with one or more of the identified chemical products.

31. The method of claim 17, wherein the accumulated information includes regulations governing transportation and use of chemicals identified in material safety data associated with one or more of the identified chemical products.

32. The method of claim 31, wherein the regulations comprise regulations provided by a plurality of jurisdictions.

33. The method of claim 32, wherein the regulations include regulations governing transportation of the one or more of the identified chemical products.

34. The method of claim 32, wherein the regulations include regulations governing use of the one or more of the identified chemical products.

35. The method of claim 32, wherein the regulations include regulations governing sale of the one or more of the identified chemical products.

36. A system for managing regulatory information associated with environment, health and safety data, comprising:
a warehouse of regulatory data associated with a plurality of chemical products;
a database configured to maintain selected elements of the regulatory data, wherein the selected elements correspond to chemical products identified by a user;
a regulatory server configured to update the regulatory data with regulatory updates received from a plurality of regulatory authorities.

37. The system of claim 36 and further comprising an application server configured to receive regulatory information from the regulatory server and store portions of the regulatory information in the database, wherein the portions are related to one or more of the selected elements.

38. The system of claim 37, wherein the regulatory information includes certain of the regulatory updates.

39. The system of claim 37, and further comprising a plurality of filters maintained by the application server, wherein the filters operate to select the portions for storage in the database.

40. The system of claim 39, wherein the filters select the portions based on relevance of the portions to the chemical products.

41. The system of claim 40, wherein the relevance is determined based on chemical compositions of the chemical products.

42. The system of claim 40, wherein the relevance is determined by identifying regulatory requirements for the chemical products based on regulatory requirements for a group of chemicals that includes one or more of the chemical products.

43. The system of claim 37, wherein the information includes data obtained from distributed global regulatory databases and chemical expert databases.

44. The system of claim 37, wherein the accumulated information includes information obtained from data sheets related to the plurality of chemicals.

45. The system of claim 36, wherein the regulatory data is obtained from a plurality of regulatory authorities.
